(19) United States
(12) Patent Application Publication
(10) Pub. No.: US 2008/0005605 A1
(43) Pub. Date: Jan. 3, 2008

(54) PCI bus system and PCI device connection method

(75) Inventor: Masayuki Abe, Saitama-shi (JP)

Correspondence Address: OLIFF & BERRIDGE, PLC, P.O. BOX 320850, ALEXANDRIA, VA, 22320-4850, US

(73) Assignee: FUJI XEROX CO., LTD., TOKYO (JP)

(21) Appl. No.: 11/637,115

(22) Filed: Dec. 12, 2006

(30) Foreign Application Priority Data
Jun. 30, 2006 (JP) 2006-180612

(51) Int. Cl. G06F 1/12

(52) U.S. Cl. 713/400

(57) ABSTRACT

A PCI bus system includes an operating frequency detection unit that identifies each of operating frequencies of extension boards mounted on PCI slots, a device number recognition unit that recognizes the number of extension boards mounted on the PCI slots, and a frequency decision unit that decides an operating frequency of a clock signal used in a PCI bus, on the basis of the operating frequency of each of the extension boards identified by the operating frequency detection unit and the number of the extension boards that is recognized by the device number recognition unit.

### BACKGROUND

1. Technical Field

The present invention relates to an information processing system that is provided with a PCI (Peripheral Component Interconnect) bus (hereinafter, referred to as “PCI bus system”), and more particularly, it relates to a PCI device connection method to connect a PCI device, such as an extension board, with the PCI bus.

2. Related Art

In recent years, many personal computers employ a PCI bus, serving as an I/O bus, to establish connection among devices within the computer, or connection among various units that are connected to extension slots. Here, an extension slot connected to the PCI bus is referred to as “PCI slot”.

The PCI bus as described above is broadly categorized into two representative specifications of operating speed, 66 MHz and 33 MHz, and that depending on the operating frequency of each specification, there is a limit to the number of connectable devices due to an electrical load restriction.

In evaluating an electrical load onto the PCI bus, the number of the PCI slots on which the device is mounted is multiplied by two, and the number of the onboard PCI devices (the devices being directly connected to the PCI bus) is added thereto. Then, by checking whether or not the number thus obtained is within a specified value, it is generally determined whether or not the electrical load is within permissible limits. Here, the electrical load of the PCI slot on which the device is mounted is converted to twice the load of the onboard PCI device, because the load of the device connected to the PCI bus via the PCI slot is put under a heavier load compared to the device connected onboard, due to the intervention of the PCI slot.

In order to support devices having different operating speeds, it is necessary to separate the bus via bus bridges supporting respective operating frequencies. However, if two buses cannot be implemented separately due to a limitation of the system, it is required to use one bus bridge to connect each of the devices. Therefore, in the conventional PCI system, it is necessary to perform implementation by fixedly selecting either one of the frequencies.

### SUMMARY

According to an aspect of the present invention, there is provided a PCI bus system including an operating frequency detection unit that identifies each of operating frequencies of extension boards mounted on PCI slots, a device number recognition unit that recognizes the number of the extension boards mounted on the PCI slots, a frequency decision unit that decides an operating frequency of a clock signal used in a PCI bus, on the basis of the operating frequency of each of the extension boards identified by the operating frequency detection unit and the number of the extension boards that is recognized by the device number recognition unit.

### BRIEF DESCRIPTION OF THE DRAWINGS

Exemplary embodiments of the present invention will be described in detail based on the following figures, wherein:

FIG. 1 is a block diagram showing a PCI bus system according to a first exemplary embodiment of the present invention;

FIG. 2 illustrates a specific method of how the operating frequency detection unit 601 and the device number recognition unit 602 as shown in FIG. 1 identify the operating frequencies and the number of the extension boards mounted on the PCI slots 70₁ to 70₅;

FIG. 3 illustrates output logic from the frequency decision unit 603 according to the first exemplary embodiment of the present invention;

FIG. 4 is a flowchart showing an operation of the frequency decision unit 603 according to the first exemplary embodiment of the present invention;

FIG. 5 illustrates output logic from the frequency decision unit 603 according to a second exemplary embodiment of the present invention; and

FIG. 6 is a flowchart showing an operation of the frequency decision unit 603 according to the second exemplary embodiment of the present invention.

### DETAILED DESCRIPTION

Next, an aspect of the present invention will be explained with reference to the accompanying drawings.

### First Exemplary Embodiment

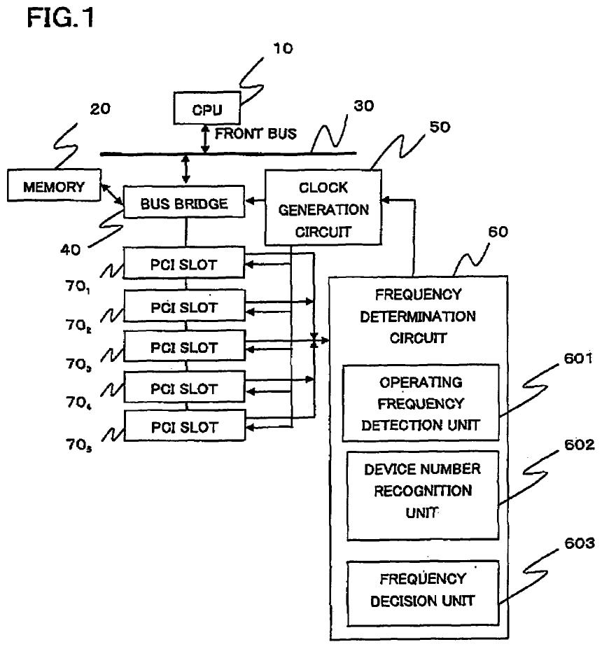

FIG. 1 is a block diagram showing a PCI bus system according to a first exemplary embodiment of the present invention. As shown in FIG. 1, the PCI bus system according to the present exemplary embodiment is provided with a CPU 10, a memory 20, a bus bridge 40, a clock generation circuit 50, a frequency determination circuit 60, and PCI slots 70₁ to 70₅. The CPU 10 and the bus bridge 40 are each connected via a front bus 30. In addition, the frequency determination circuit 60 incorporates an operating frequency detection unit 601, a device number recognition unit 602, and a frequency decision unit 603.

In the present exemplary embodiment, an explanation will be made taking the PCI bus system provided with five PCI slots 70₁ to 70₅, as a way of example. However, it is to be noted that the number of PCI slot is not limited to five.

The operating frequency detection unit 601 identifies each of operating frequencies of extension boards mounted on the PCI slots 70₁ to 70₅. The device number recognition unit 602 recognizes the number of the extension boards mounted on the PCI slots 70 to 70₅.

The frequency decision unit 603 decides an operating frequency of a clock signal used in the PCI bus, on the basis of the operating frequency of each of the extension boards identified by the operating frequency detection unit 601 and the number of extension boards recognized by the device number recognition unit 602.

Specifically, the frequency decision unit 603 decides the highest frequency within a range guaranteeing proper operation as an operating frequency of the clock signal, out of frequencies allowing any of the extension boards mounted on the PCI slots 70₁ to 70₅ to be operable, on the basis of detection results by the operating frequency detection unit 601 and the device number recognition unit 602.

The clock generation circuit 50 generates the clock signal of the operating frequency that is decided by the frequency decision unit 603 of the frequency determination circuit 60, and outputs the generated clock signal to each device, such as PCI slots 70₁ to 70₅, connected to the PCI bus.

An explanation will be made as to a case in which the PCI bus system according to the present exemplary embodiment of the present invention selects either one of the frequencies, 33 MHz and 66 MHz, to be used as an operating frequency of the clock signal in the PCI bus.

An extension board having the operating frequency of 66 MHz standard (hereinafter, referred to as “66 MHz standard product”) is operable with the operating frequency, any one of 33 MHZ and 66 MHz. However, the extension board having the operating frequency of 33 MHz standard (hereinafter, referred to as “33 MHz standard product”) is operable only with the frequency of 33 MHz.

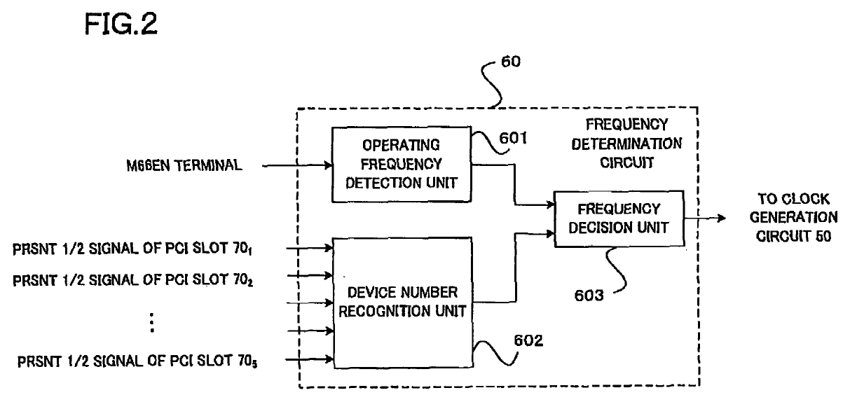

Next, with reference to FIG. 2, there will be explained a specific method in which the operating frequency detection unit 601 identifies the operating frequencies and the device number recognition unit 602 recognizes the number of the extension boards mounted on the PCI slots 70₁ to 70₅.

Firstly, as shown in FIG. 2, an M66EN terminal of each slot, being subjected to daisy chain connection, is connected to the operating frequency detection unit 601, so that it is determined whether or not there exists 33 MHz standard product within the PCI slots 70₁ to 70₅. When a signal level of the M66EN terminal is a low level (hereinafter, represented by “L”), the operating frequency detection unit 601 recognizes that at least one 33 MHz standard extension board exists in the extension slot.

As described, the operating frequency detection unit 601 identifies the operating frequency of the mounted extension board, on the basis of the M66EN terminal logic of the PCI slots 70₁ to 70₅.

Here, the M66EN terminal shows a high level (hereinafter, represented by “H”), when 66 MHz standard product is mounted. Therefore, all M66EN terminals of the respective PCI slots 70₁ to 70₅ may be connected to the operating frequency detection unit 601. However, if at least one 33 MHz standard product exists, it is necessary to set the operating frequency of the clock signal in the PCI bus to 33 MHz. Accordingly, it is only required to determine whether all the extension boards mounted on the PCI slots 70₁ to 70₅ are 66 MHz standard products or there exists a PCI slot on which 33 MHz standard products are mounted. In view of this situation, it is sufficient that all M66EN terminals of the PCI slots 70₁ to 70₅ are united to be connected to the operating frequency detection unit 601.

In order to recognize that an extension board is mounted on the PCI slots 70₁ to 70₅, PRSNT ½ signals of the PCI slots 70₁ to 70₅ are respectively connected to the device number recognition unit 602.

As described, the device number recognition unit 602 recognizes the number of mounted extension boards, on the basis of PRSNT ½ signal logic of the PCI slots 70₁ to 70₅.

Here, two signals, a PRSNT 1 signal and a PRSNT 2 signal, are collectively represented as “PRSNT ½ signal”. This signal is originally provided to indicate power consumption of the extension board mounted on the PCI slot. According to a combination of the PRSNT ½ signal logic, it is possible to learn approximate power consumption of the extension boards mounted on the PCI slots. If no extension board is mounted on the PCI slots, all the PRSNT ½ signals indicate level L, and if an extension board is mounted, any of the PRSNT ½ signals is turned to be level H. Therefore, by detecting that any of the PRSNT ½ signals indicates level H, it is possible to recognize that an extension board has been mounted on the pertinent slot.

In the following description, “PRSNT ½ signal indicates H” means that one of the PRSNT 1 signal and PRSNT 2 signal indicates H, and “PRSNT ½ signal indicates L” means that both of the PRSNT 1 signal and PRSNT 2 signal indicate L.

Therefore, when the PRSNT ½ signal from each of the PCI slots 70₁ to 70₅ indicates L, the device number recognition unit 602 recognizes that an extension board is not mounted on the pertinent PCI slot, and when it indicates H, it is recognized that an extension board is mounted thereon. Then, the device number recognition unit 601 checks respective PRSNT ½ signal logic of five PCI slots 70₁ to 70₅, thereby recognizing the total number of mounted extension boards.

In the following, a procedure will be explained, in which the frequency decision unit 603 decides an operating frequency of the clock signal that is used in the PCI bus, on the basis of the operating frequency of each of extension boards recognized by the operating frequency detection unit 601 and the number of extension boards recognized by the device number recognition unit 602.

When the M66EN signal indicates L and the operating frequency detection unit 601 determines that at least one 33 MHz standard product is mounted, the frequency decision unit 603 decides to set the operating frequency to 33 MHz, irrespective the number of the mounted extension boards.

On the other hand, when the M66EN signal indicates H and the operating frequency detection unit 601 determines that there is no 33 MHz standard product mounted, the frequency decision unit 603 selects an operating frequency on the basis of the number of mounted extension boards.

Specifically, the frequency decision unit 603 decides to set the operating frequency to 66 MHz, when all the mounted extension boards are 66 MHz standard products, and the number of the mounted extension boards is equal to or less than two. If the number of the extension board is three or more, the operating frequency is set to 33 MHz.

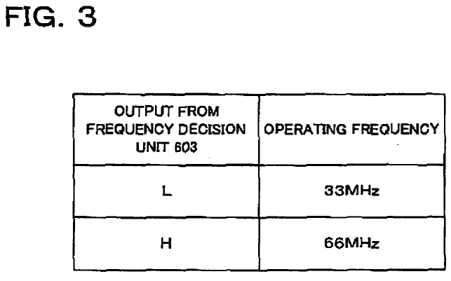

According to the logic as shown in FIG. 3, for example, the frequency decision unit 603 notifies the clock generation circuit 50 of thus decided operating frequency. The example as shown in FIG. 3 illustrates that when the signal logic from the frequency decision unit 603 indicates L, 33 MHz is selected as the operating frequency, and when it indicates H, 66 MHz is selected.

The clock generation circuit 50 generates a clock signal of the frequency on the basis of the output signal logic from this frequency decision unit 603, and outputs it to the respective PCI devices.

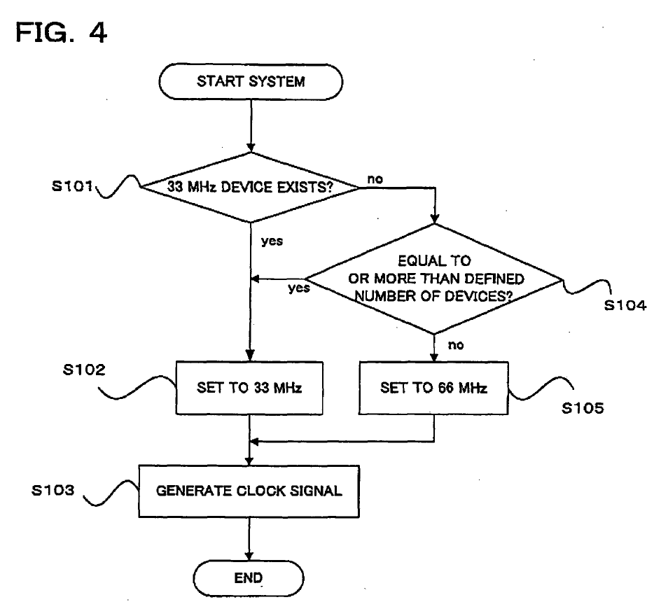

Next, with reference to the flowchart as shown in FIG. 4, operations of the frequency determination circuit 60 and the clock generation circuit 50 in the PCI bus system according to the present exemplary embodiment will be explained.

When the system is started, in the frequency determination circuit 60, the operating frequency detection unit 601 firstly determines whether or not there exists an extension board having the operating frequency of 33 MHz among the extension boards mounted on the PCI slots 70₁ to 70₅ (S101). Then, when it is confirmed that at least one extension board having the operating frequency of 33 MHz exists, the frequency decision unit 603 decides to set the operating frequency of the PCI bus to 33 MHz (S102).

When it is determined that there is no existence of extension board having the operating frequency of 33 MHz, in other words, when it is determined that all the extension boards are 66 MHz standard products, the frequency decision unit 603 determines whether the number of the extension board mounted on the PCI slots 70₁ to 70₅ are equal to or more than a defined number, which is three in this example (S104). When it is determined that the number of the extension board is equal to or more than the defined number, the frequency decision unit 603 decides to set the operating frequency of the PCI bus to 33 MHz (S102) When it is less than the defined number, that is, when it is equal to or less than two, the frequency decision unit 603 decides to set the operating frequency of the PCI bus to 66 MHz (S105).

Then, the clock generation circuit 50 generates a clock signal having the operating frequency decided by the frequency decision unit 603, as an operating clock of the PCI bus, and outputs the generated clock signal (S103).

According to the PCI bus system of the present exemplary embodiment, when the operating frequencies in one bus bridge are switched for use, the operating frequency is set to 66 MHz allowing performance-emphasized high-speed operation in the case where the number of extension board being mounted is equal to or less than two, which is less than the defined number, three. In the case where the number of the extension board being mounted is large, such as three or more, the operating frequency is reduced to 33 MHz, thereby allowing simultaneous operation of all the extension boards.

### Second Exemplary Embodiment

Next, there will be explained a second exemplary embodiment of the present invention.

The first exemplary embodiment above is directed to a system that selects either one of the two frequencies, 33 MHz and 66 MHz, as an operating frequency of a clock signal of the PCI bus. However, besides those two frequencies, it is also possible to set another frequency as an operating frequency of the PCI bus system.

In the second exemplary embodiment of the present invention, an explanation will be made taking as an example, a PCI system in which frequencies 55 MHz and 60 MHz are selectable, in addition to the frequencies 33 MHz and 66 MHz. It is assumed in the following explanation that the maximum numbers of the extension boards available for use are two, three, and four, respectively when the operating frequency of the PCI bus is 66 MHz, 60 MHz, and 55 MHz.

The present exemplary embodiment allows a step-by-step switching of frequencies according to the number of connected extension boards, without straightway switching the frequency to 33 MHz, when all the extension boards mounted on the PCI slots are 66 MHz standard products only and the number of mounted extension boards is equal to or more than three.

The PCI bus system according to the present exemplary embodiment has basically the same configuration as that of the PCI bus system according to the first exemplary embodiment. There is a difference only in the operation of the frequency decision unit 603 within the frequency determination circuit 60 as shown in FIG. 2. Therefore, referring to the reference numerals used in explaining the first exemplary embodiment, the PCI bus system of the present exemplary embodiment will be explained.

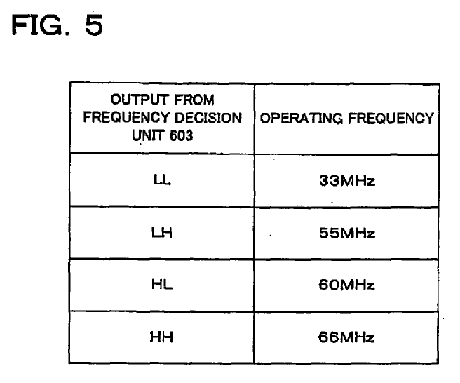

As shown in FIG. 5, the frequency decision unit 603 in the present exemplary embodiment notifies the clock generation circuit 50 of the operating frequency that has been decided by the use of two signals. This example in FIG. 5 illustrates that when the logic of the two signals from the frequency decision unit 603 is “LL”, 33 MHz is selected as the operating frequency, that when it is “LH”, 55 MHz is selected, that when it is “HL”, 60 MHz is selected, and that when it is “HH”, 66 MHz is selected.

The clock generation circuit 50 in the present exemplary embodiment generates a clock signal having a frequency according to a combination of the logic of output signals from this frequency decision unit 603, and outputs the generated clock signal to each PCI device.

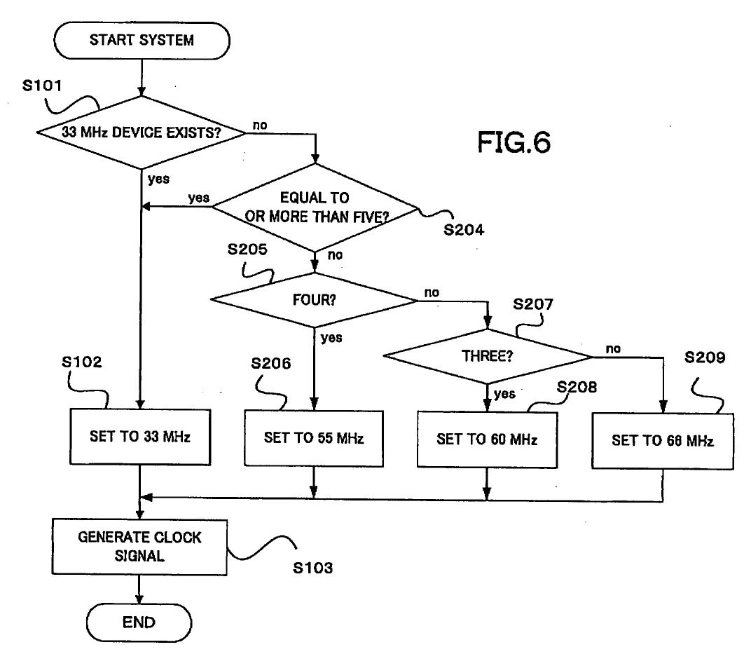

Next, with reference to the flowchart as shown in FIG. 6, operations of the frequency decision unit 603 in the PCI bus system according to the present exemplary embodiment will be explained.

When the system is started, in the frequency determination circuit 60, the operating frequency detection unit 601 firstly determines whether or not there exists an extension board having the operating frequency of 33 MHz among the extension boards mounted on the PCI slots 70₁ to 70₅ (S101). When it is confirmed that at least one extension board having the operating frequency of 33 MHz exists, the frequency decision unit 603 decides to set the operating frequency of the PCI bus to 33 MHz (S102). The operations so far are the same as those in the flowchart of the first exemplary embodiment shown in FIG. 4.

In S101, when it is determined that no extension board having the operating frequency of 33 MHz exists, in other words, when it is determined that all the extension boards are 66 MHz standard products, the frequency decision unit 603 determines whether the number of the extension boards mounted on the PCI slots 70₁ to 70₅ are equal to or more than five (S204). When it is determined that the number of the extension boards is equal to or more than five, the frequency decision unit 603 decides to set the operating frequency of the PCI bus to 33 MHz (S102). When it is less than five, the frequency decision unit 603 determines whether or not the number of extension board being mounted is four (S205). In S205, when it is determined that the number of extension board being mounted is four, the frequency decision unit 603 decides to set the operating frequency of the PCI bus to 55 MHz (S206). If the number is determined not to be four, it is further determined whether or not the number of mounted extension boards is three (S207). In S207, if it is determined that the number of extension board being mounted is three, the frequency decision unit 603 decides to set the operating frequency of the PCI bus to 60 MHz (S208). If the number is determined not to be three, it is decided that the operating frequency of the PCI bus is set to 66 MHz (S209).

Then, the clock generation circuit 50 generates a clock signal having the operating frequency decided by the frequency decision unit 603, as an operating clock of the PCI bus, and outputs the generated clock signal (S103).

The PCI bus system of the present exemplary embodiment allows a step-by-step switching of frequencies according to the number of connected extension boards, without straightway switching the frequency to 33 MHz, when all the extension boards mounted on the PCI slots are 66 MHz only and the number of extension board being mounted is equal to or more than three.

The foregoing description of the exemplary embodiments of the present invention has been provided for the purposes of illustration and description. It is not intended to be exhaustive or to limit the present invention to the precise forms disclosed. Obviously, many modifications and variations will be apparent to practitioners skilled in the art. The exemplary embodiments were chosen and described in order to best explain the principles of the present invention and its practical applications, thereby enabling others skilled in the art to understand the present invention for various embodiments and with the various modifications as are suited to the particular use contemplated. It is intended that the scope of the present invention be defined by the following claims and their equivalents.

What is claimed is:

1. A PCI bus system, comprising;
an operating frequency detection unit that identifies each of operating frequencies of extension boards mounted on PCI slots,
a device number recognition unit that recognizes the number of extension boards mounted on the PCI slots, and
a frequency decision unit that decides an operating frequency of a clock signal used in a PCI bus, on the basis of the operating frequency of each of the extension boards identified by the operating frequency detection unit and the number of the extension boards that is recognized by the device number recognition unit.

2. The PCI bus system according to claim 1, further comprising:
a clock generation unit that generates a clock signal of the operating frequency decided by the frequency decision unit, and outputs the generated clock signal to each device connected to the PCI bus.

3. The PCI bus system according to claim 1,
wherein the frequency decision unit decides the highest frequency within a range guaranteeing proper operation as the operating frequency of the clock signal, out of frequencies allowing any of the extension boards mounted on the PCI slots to be operable, on the basis of detection results by the operating frequency detection unit and the device number recognition unit.

4. The PCI bus system according to claim 3, further comprising:
a clock generation unit that generates a clock signal of the operating frequency decided by the frequency decision unit, and outputs the generated clock signal to each device connected to the PCI bus.

5. The PCI bus system according to claim 1, wherein the operating frequency detection unit identifies the operating frequencies of the extension boards mounted on the PCI slots, on the basis of M66EN terminal logic of each of the PCI slots.

6. The PCI bus system according to claim 1, wherein the device number recognition unit recognizes the number of extension boards mounted on the PCI slots on the basis of PRSNT ½ signal logic of each of the PCI slots.

7. A PCI device connection method, comprising;
identifying each of operating frequencies of extension boards mounted on PCI slots,
recognizing the number of the extension boards mounted on the PCI slots, and
deciding an operating frequency of a clock signal used in the PCI bus, on the basis of the identified operating frequency of each of the extension boards and the recognized number of the extension boards.

8. The PCI device connection method according to claim 7, wherein a clock signal having the frequency decided as the operating frequency is generated and outputted to each device that is connected to the PCI bus.

9. The PCI device connection method according to claim 7, wherein upon deciding the operating frequency of the clock signal used in the PCI bus, the highest frequency within a range guaranteeing proper operation is selected as the operating frequency of the clock signal, out of frequencies allowing any of the extension boards mounted on the PCI slots to be operable, on the basis of the identified operating frequencies of the extension boards and the recognized number of extension board.

10. The PCI device connection method according to claim 9, wherein a clock signal having the frequency decided as the operating frequency is generated and outputted to each device that is connected to the PCI bus.

11. The PCI device connection method according to claim 7, wherein, in identifying each of the operating frequencies of the extension boards mounted on the PCI slots, the operating frequencies of the extension boards mounted on the PCI slots are identified on the basis of M66EN terminal logic of each of the PCI slots.

12. The PCI device connection method according to claim 7, wherein, in recognizing the number of extension boards mounted on the PCI slots, the number of the extension boards mounted on the PCI slots is recognized on the basis of PRSNT ½ signal logic of each of the PCI slots.
